(19) United States
(12) Patent Application Publication
(10) Pub. No.: US 2026/0117041 A1
(43) Pub. Date: Apr. 30, 2026

(54) BALANCING WEIGHT COMPOSITION WITH EXCELLENT CHEMICAL RESISTANCE AND BALANCING WEIGHT INCLUDING SAME

(71) Applicants: HYUNDAI MOTOR COMPANY, Seoul (KR); KIA CORPORATION, Seoul (KR); FLEXON, INC., GWACHEON-SI (KR)

(72) Inventors: Ho Dong Kim, Hwaseong-si (KR); Kang Sun Lee, Hwaseong-si (KR); Hyung Seok Kim, Hwaseong-si (KR)

(73) Assignees: HYUNDAI MOTOR COMPANY, Seoul (KR); KIA CORPORATION, Seoul (KR); FLEXON, INC., GWACHEON-SI (KR)

(21) Appl. No.: 19/051,091

(22) Filed: Feb. 11, 2025

(30) Foreign Application Priority Data
Oct. 28, 2024 (KR) 10-2024-0148144

(51) Int. Cl. C08K 3/22; C08K 3/11; C08K 5/095; F16F 15/32

(52) U.S. Cl. CPC C08K 3/22; C08K 3/11; C08K 5/095; F16F 15/324; C08K 2003/2296; F16F 2224/025

(57) ABSTRACT

A balancing weight composition with excellent chemical resistance and a balancing weight including the same, in which polar rubber, an activator, and metal particles are contained in predetermined amounts. The balancing weight using the balancing weight composition has excellent chemical resistance by including polar rubber, is capable of preventing environmental pollution due to heavy metals and suppressing rust generation, has excellent adhesion to the curved surface of a wheel and high extrudability and bending resistance, and is capable of inhibiting interfacial peeling and lifting phenomena.

### CROSS-REFERENCE TO RELATED APPLICATION

This application claims, under 35 U.S.C. § 119(a), the benefit of priority from Korean Patent Application No. 10-2024-0148144, filed on Oct. 28, 2024, the entire contents of which are incorporated herein by reference.

### BACKGROUND

### (a) Technical Field

The present disclosure relates to a balancing weight composition with excellent chemical resistance and a balancing weight including the same, in which polar rubber, an activator, and metal particles are contained, and which provides excellent chemical resistance.

### (b) Background Art

In general, when a tire wheel of a vehicle has an unbalanced portion, it will vibrate due to centrifugal force as it rotates, which will cause issues such as noise, uneven tire wear, steering wheel shaking, etc. In particular, wheel balance should be accurate when driving at high speed. Typically to correct the imbalance of a vehicle wheel, a wheel balance weight having appropriate weight is installed on any portion of the edge opposite to the portion of the wheel or rim that is causing the weight imbalance, thereby generating centrifugal force in the opposite direction to achieve balance.

Conventionally, a method of attaching a weight made of lead (Pb) in units of 5 g as a balancing weight material to a tire or rim using a tape-type adhesive has been used as a balance. However, lead (Pb) is classified as an environmental hazard, and there are problems such as corrosion caused by salt water when left for a long period of time, and loss of precision in units of 5 g due to lack of flexibility. In addition, when the weight is applied to the curved surface of a vehicle wheel using a tape-type adhesive, problems such as reduced adhesion, and interfacial peeling and lifting during long-term use can occur. In addition, application of a conventional balancing weight is carried out manually, rather than by an automated process, so the frequency of error can be high.

### SUMMARY

The present disclosure has been made keeping in mind the problems encountered in the related art, and is intended to provide a balancing weight composition that has high adhesion to the curved surface of a vehicle wheel, is easily molded, and has excellent durability and bending resistance so that it does not break even during repeated operations.

In particular, the present disclosure is intended to provide a balancing weight composition having excellent robustness under various chemical durability conditions.

The objects of the present disclosure are not limited to the foregoing. The objects of the present disclosure will be able to be clearly understood through the following description and to be realized by the features, aspects, and embodiments described in the claims, illustrative examples, and combinations thereof.

An embodiment of the present disclosure provides a balancing weight composition, including polar rubber, an activator, and metal particles, in which the balancing weight composition may include, based on 100 parts by weight (phr) of the polar rubber, 1.5 phr to less than 60 phr of the activator and greater than 350 phr to less than 1,750 phr of the metal particles.

In some non-limiting embodiments, the polar rubber may include any one selected from the group consisting of nitrile butadiene rubber (NBR), hydrogenated nitrile butadiene rubber (H-NBR), chloroprene rubber (CR), and combinations thereof.

As such, in embodiments the nitrile butadiene rubber may have a Mooney viscosity (ML1+4) of 40 to 75 at 100° C. (as measured using a Mooney Viscometer, as known and available in the art).

In yet further embodiments, the hydrogenated nitrile butadiene rubber may have a Mooney viscosity (ML1+4) of 55 to 75 at 100° C.

In some embodiments, the chloroprene rubber may have a Mooney viscosity (ML1+4) of 30 to 60 at 100° C.

In some non-limiting embodiments, the activator may include any one selected from among an inorganic oxide, a fatty acid, and combinations thereof.

In embodiments, the inorganic oxide may include any one selected from the group consisting of zinc oxide (ZnO), tin oxide (SnO₂), aluminum oxide (Al₂O₃), zirconium oxide (ZrO₂), and combinations thereof.

In embodiments, the fatty acid may be selected from among a saturated fatty acid and an unsaturated fatty acid. In some further embodiments, the saturated fatty acid may include any one selected from the group consisting of stearic acid, caprylic acid, lauric acid, myristic acid, arachidic acid, and combinations thereof. In some other further embodiments, the unsaturated fatty acid may include any one selected from the group consisting of oleic acid, elaidic acid, linoleic acid, ricinoleic acid, and combinations thereof.

In one embodiment, the balancing weight composition may include 1 phr to less than 55 phr of the inorganic oxide and 0.5 phr to 5 phr of the fatty acid (based on 100 parts by weight (phr) of the polar rubber).

In some non-limiting embodiments, the metal particles may include any one selected from the group consisting of austenitic stainless steel, ferritic stainless steel, martensitic stainless steel, and combinations thereof.

In some further embodiments, the average particle diameter (D50) of the metal particles may be 1 μm to 150 μm.

In yet further embodiments, the metal particles may have a particle size of 30 μm to 120 μm, the tap density of the metal particles may be 6.0 to 10.0 g/cm³, and the apparent density of the metal particles may be 4.0 to 8.0 g/cm³.

In one embodiment, the balancing weight composition may further include a plasticizer.

In some non-limiting embodiments, the plasticizer may include any one selected from the group consisting of a paraffinic compound, a naphthenic compound, an olefinic compound, an aromatic compound, and combinations thereof.

In some embodiments, the balancing weight composition may include greater than 0 phr to 30 phr of the plasticizer (based on 100 parts by weight (phr) of the polar rubber).

In one embodiment, the balancing weight composition may further include any one selected from the group consisting of an acid acceptor, an anti-aging agent, a filler, and combinations thereof.

In one embodiment, the balancing weight composition may include, based on 100 parts by weight (phr) of the polar rubber, 1 phr to 2 phr of an inorganic oxide, 0.8 phr to 2 phr of a fatty acid, 5 phr to 30 phr of a plasticizer, and 500 phr to 1,580 phr of the metal particles.

In one embodiment, the balancing weight composition does not include a crosslinking agent or a crosslinking accelerator.

Another embodiment, the present disclosure provides a balancing weight manufactured by compression molding of the balancing weight composition in accordance with the aspects, embodiments, and examples described herein.

As such, in some further embodiments the balancing weight may be applied to a vehicle wheel. Thus, some embodiments provide for a vehicle wheel comprising the balancing weight composition and/or the balancing weight manufactured in accordance with the disclosure.

### BRIEF DESCRIPTION OF THE DRAWINGS

Various aspects, embodiments, and features of the present disclosure will now be described in detail referring to certain exemplary embodiments thereof illustrated in the accompanying drawings, which are provided herein by way of illustration only, and thus do not limit the disclosure.

FIG. 1 is a photograph of a balancing weight to which a composition according to an embodiment of the present disclosure is applied and with a film attached;

FIG. 2 are photographs showing results of evaluation of bendability of balancing weights according to Examples 1 and 3 and Comparative Example 2;

FIG. 3 is a photograph showing results of evaluation of weather resistance of a balancing weight according to Comparative Example 3; and

FIG. 4 is a photograph showing results of evaluation of ozone resistance of a balancing weight according to Reference Example 9.

### DETAILED DESCRIPTION

The objects, features and advantages provided by the disclosure will be more clearly understood from the following embodiments and preferred embodiments taken in conjunction with the accompanying drawings. However, the present disclosure is not limited to the embodiments disclosed herein, and may be modified into different forms that still fall within the scope of the disclosure and claims. These illustrative embodiments are provided merely to explain the disclosure and to clarify the present disclosure to those skilled in the art.

Throughout the drawings, the same reference numerals will refer to the same or like elements. For the sake of clarity, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A balancing weight composition according to the present disclosure may include polar rubber, an activator, and metal particles. In the balancing weight composition according to the present disclosure, polar rubber having excellent chemical resistance and elasticity and metal particles having high specific gravity are used in combination, thereby preventing environmental pollution due to heavy metals compared to existing steel-type balancing weights, suppressing rust generation, exhibiting high adhesion to the curved surface of a wheel and high extrudability and bending resistance, and inhibiting interfacial peeling and lifting phenomena.

As such, in embodiments the balancing weight composition may include from 1.5 phr to 60 phr of activator and from 350 phr to 1,750 phr of the metal particles based on 100 parts by weight (phr) of the polar rubber. Preferably the balancing weight composition may include 1.5 phr to less than 60 phr of the activator and greater than 350 phr to less than 1,750 phr of the metal particles based on 100 parts by weight (phr) of the polar rubber. When the amounts of the components of the balancing weight composition fall in the above ranges, excellent blendability and bendability, high specific gravity, and superior chemical resistance including fuel resistance, ozone resistance, and weather resistance in a balanced manner may result.

Individual components included in the balancing weight composition are described in detail below.

### Polar Rubber

The balancing weight composition according to the present disclosure includes polar rubber. The polar rubber is rubber having a polar group in the polymer backbone and a large dipole moment, and has excellent heat resistance, hydrolysis resistance, weather resistance, and ozone resistance. Also, by virtue of high polarity, the polar rubber has excellent blendability with metal materials.

The polar rubber may include, for example, any one selected from the group consisting of nitrile butadiene rubber (NBR), hydrogenated nitrile butadiene rubber (H-NBR), chloroprene rubber (CR), and combinations thereof.

The polar rubber including nitrile butadiene rubber, hydrogenated nitrile butadiene rubber, or chloroprene rubber may have improved chemical resistance because it contains a chlorine functional group (CR) and an acrylonitrile group (NBR, H-NBR) having excellent fuel resistance to fuel such as gasoline, etc.

The nitrile butadiene rubber has very high resistance to a wide range of organic solvents and vehicle lubricants, and excellent tensile strength, tear resistance, and low-temperature flexibility. The nitrile butadiene rubber also has the advantage of being economical and easily available as a general-purpose material. Examples of the nitrile butadiene rubber include KRYNAC 3345F, PERBUNAN N3445 (Arlanxeo), Nipol 1072 (Zeon), and the like.

The hydrogenated nitrile butadiene rubber may have better heat resistance than the nitrile butadiene rubber, and may generally be used even under environmental conditions of 150° C. or higher. In addition, the hydrogenated nitrile butadiene rubber has excellent chemical resistance and thus good resistance to oil, fuel, and lubricants, and excellent oxidation stability and ozone resistance. By virtue of excellent wear resistance, the hydrogenated nitrile butadiene rubber may also exhibit physical stability when used in balancing weights. Examples of the hydrogenated nitrile butadiene rubber may include THERBAN 3407, THERBAN 3406 (Arlanxeo), ZETPOL 2000, ZETPOL 2020 (Zeon), and the like.

The chloroprene rubber contains a chlorine polar group and thus has excellent ozone resistance and weather resistance. In addition, the chloroprene rubber has excellent chemical resistance and thus good resistance to oil, fuel, and lubricants, and superb heat resistance and flame retardancy, thus exhibiting fire stability when applied to vehicle parts under high temperature and high heat conditions. Examples of the chloroprene rubber may include Neoprene AD10, Neoprene WRT, Neoprene FB (Denka), and the like.

In one embodiment, the nitrile butadiene rubber may have a Mooney viscosity (ML1+4) of 40 to 75 at 100° C., the hydrogenated nitrile butadiene rubber may have a Mooney viscosity (ML1+4) of 55 to 75 at 100° C., and the chloroprene rubber may have a Mooney viscosity (ML1+4) of 30 to 60 at 100° C. As used herein and in accordance with standards in the art, the term ML (1+4) is a Mooney viscosity measurement that indicates the viscosity of a material in Mooney units (MU) after a one-minute preheating time and a four-minute test time, where:
M: Indicates Mooney, L: Indicates that a large rotor was used, 1: Indicates one minute preheating time, 4: Refers to the time in minutes after starting the rotor.

If the Mooney viscosity (ML1+4) of the polar rubber at 100° C. is too low, mechanical properties may deteriorate, whereas if it is too high, processability may deteriorate.

### Activator

The balancing weight composition according to the present disclosure includes an activator. The activator may serve to improve blendability and dispersibility between components included in the balancing weight composition and to enhance filling properties of stainless steel powder.

In one embodiment, the activator may include any one selected from among an inorganic oxide, a fatty acid, and combinations thereof.

In some non-limiting embodiments, the inorganic oxide may include, for example, any one selected from the group consisting of zinc oxide (ZnO), tin oxide (SnO₂), aluminum oxide (Al₂O₃), zirconium oxide (ZrO₂), and combinations thereof. In some preferred embodiments the inorganic oxide comprises zinc oxide which is capable of improving dispersibility of polar rubber during the extrusion process.

The fatty acid is selected from among a saturated fatty acid and an unsaturated fatty acid. In some non-limiting embodiments, the saturated fatty acid may include, for example, any one selected from the group consisting of stearic acid, caprylic acid, lauric acid, myristic acid, arachidic acid, and combinations thereof. In some non-limiting embodiments, the unsaturated fatty acid may include, for example, any one selected from the group consisting of oleic acid, elaidic acid, linoleic acid, ricinoleic acid, and combinations thereof. In some preferred embodiments the fatty acid comprises stearic acid which has high compatibility without producing non-uniform particles when blended with polar rubber.

As polar rubber has relatively low specific gravity, the balancing weight composition includes metal particles to increase the specific gravity thereof. However, due to problems such as reduced blendability, and bendability when metal particles are included in an amount equal to or greater than a predetermined amount, it can be difficult to increase the amount of metal particles in high amounts. The balancing weight composition according to the present disclosure includes an inorganic oxide having high specific gravity as an activator, thus compensating for a decrease in specific gravity of the balancing weight due to the polar rubber having low specific gravity.

Also, since the polar rubber and inorganic oxide included in the balancing weight composition according to the present disclosure have good compatibility with each other, mixing efficiency may be improved, and the amount of the inorganic oxide may be increased to less than 55 phr as described herein.

Thus, in one embodiment, the balancing weight composition may include from 1 phr to 55 phr of the inorganic oxide and from 0.5 phr to 5 phr of the fatty acid based on 100 phr of the polar rubber. Preferably the balancing weight composition may include 1 phr to less than 55 phr of the inorganic oxide and 0.5 phr to 5 phr of the fatty acid based on 100 phr of the polar rubber.

If the amount of the inorganic oxide is less than 1 phr, the activation effect may be insufficient, making effective mixing difficult, and thus metal particles in powder form may be separated. On the other hand, if the amount of the inorganic oxide is 55 phr or more, agglomeration of metal particles may occur, and fatigue resistance may decrease due to reduced dispersibility.

If the amount of the fatty acid is less than 0.5 phr, it can be difficult to obtain filling properties of the metal particles, causing cracking and separation of the metal particles. On the other hand, if the amount of the fatty acid exceeds 5 phr, unreacted fatty acid may accumulate, causing separation of metal particles when mixing the composition, which may result in discoloration and/or migration.

### Metal Particles

The balancing weight composition according to the present disclosure may include metal particles. The metal particles may serve to increase specific gravity of the balancing weight composition and may have superior corrosion resistance compared to conventional steel-type balancing weights.

The metal particles may include metal that is in powder form, is corrosion resistant, and has high density and/or specific gravity. Non-limiting examples thereof may include stainless steel, titanium, nickel, chromium, zinc, copper, nickel-copper alloy (Monel), nickel-chromium alloy (Inconel), nickel-molybdenum-chromium alloy (Hastelloy), and the like. In some preferred embodiments, stainless steel powder having excellent corrosion resistance and high density and specific gravity is used as the metal particles.

In such embodiments, the stainless steel powder may include at least one selected from among steel species such as SUS 300 series, SUS 400 series, and SUS 600 series, all having excellent corrosion resistance.

For example, the SUS 300 series includes austenitic stainless steel and has excellent toughness and ductility. Specific examples of the SUS 300 series include SUS 304, 309, 310, 314, 330, 303, 316, 317, and the like, and SUS 304 is employed in some preferred embodiments.

The SUS 400 series includes ferritic stainless steel and is magnetic. Specific examples of the SUS 400 series include SUS 430, 444, 434, 436, 405, 409, and the like, and SUS 430 can be used in some preferred embodiments.

The SUS 600 series includes martensitic stainless steel and has excellent strength and corrosion resistance. Specific examples of the SUS 600 series include SUS 630, 631, and the like, and SUS 630 is used in some preferred embodiments.

The shape of the metal particles may be irregular, planar, or spherical, but in some preferred embodiments, the use of spherical powder can improve dispersibility. The metal particles in powder form may be manufactured in a water spray or gas spray manner.

In some non-limiting embodiments, the average particle diameter (D50) of the metal particles may be 1 μm to 150 μm, preferably 30 μm to 120 μm. When the average particle size thereof falls in the above range, excellent dispersibility, high filling rate, and desired mechanical properties may be exhibited. If the average particle size of the powder is less than 1 μm or is greater than 150 μm, powder aggregation may occur, reducing dispersibility, or the filling rate may decrease, reducing the specific gravity of the composition. Herein, D50 may be a particle size at which the cumulative weight corresponds to 50% in a particle size-weight distribution.

In some non-limiting embodiments, a mixture of powdered metal particles having different particle sizes ranging from 30 μm to 120 μm may be used to form a balancing weight composition having high specific gravity. The tap density of the metal particles may be 6.0 to 10.0 g/cm³, preferably 7.0 to 10.0 g/cm³. Also, the apparent density of the metal particles may be 4.0 to 8.0 g/cm³, preferably 5.0 to 8.0 g/cm³.

Table 1 below shows experimental data of the filling density of stainless steel powder as the filler depending on the particle size. When stainless steel powder having particle sizes of 10 to 50 μm, 30 to 120 μm, and 120 to 150 μm was combined and loaded in polar rubber, high apparent density and tap density were realized upon combination and loading of stainless steel powder having a particle size of 30 to 120 μm.

TABLE 1

| Particle size of SUS powder | 1-50 μm | 30-120 μm | 120-150 μm |
|---|---|---|---|
| Tap density | 6.2 | 7.1 | 6.3 |
| Apparent density | 4.3 | 5.1 | 4.1 |

The balancing weight composition may include greater than 350 phr to less than 1,750 phr, preferably 500 phr to 1,580 phr, of the metal particles, based on 100 parts by weight (phr) of the polar rubber.

If the amount of the metal particles is 350 phr or less, the specific gravity may be too low, requiring a larger volume of balancing weight to achieve an appropriate range of specific gravity, and noise and disturbance may occur when the resulting weight is applied to vehicle wheels. On the other hand, if the amount of the metal particles is 1,750 phr or more, poor mixing may occur during mixing of the composition and manufacture of the balancing weight, separation of the metal particles may occur, and interfacial reactivity between the metal particles and the polar rubber may be insufficient, resulting in lowered fatigue resistance under repeated bending.

Here, the “Apparent density” is a density obtained by loosely filling a container with a substance without pressing it down. Apparent density is measured by either the method of measuring the apparent volume of a sample of a substance with a known mass in a scalpel cylinder (Constant Mass Method) or the method of measuring the mass of a substance filled in a container with a known volume (Constant Volume Method). For example, it can be measured using ASTM D1895 method, or other standards as known in the art.

The “tap density” is the apparent density obtained by mechanically tapping the measuring container containing the powder sample. The measurement of tapped density can be measured by the constant mass method, which measures the volume of a tapped sample when the container is filled with a known mass, or by the constant volume method, which measures the mass of a tapped sample in a container with a known volume. For example, it can be measured using ISO 3953, ASTM B527-22 method, or other standards as known in the art.

### Plasticizer

In one embodiment, the balancing weight composition may further include a plasticizer. The plasticizer may serve to improve blendability and processability of a balancing weight composition including polar rubber, and also to prevent aging of a balancing weight manufactured using the composition and impart flexibility thereto.

In some non-limiting embodiments, the plasticizer may include any one selected from the group consisting of a paraffinic compound, a naphthenic compound, an olefinic compound, an aromatic compound, and combinations thereof.

In some further embodiments, aliphatic or aromatic oil, or paraffin wax (linear, branched, or ring type) may be used as the plasticizer, and for example, an aromatic, naphthenic, or paraffinic mineral oil plasticizer (e.g., MES (mild extracted solvate)) may be used. More specific non-limiting examples thereof include products such as Shellflex371 (Shell), Synfluid 6cSt (Chevron), and the like. As such, the plasticizer added to the balancing weight composition may have a solubility parameter similar to that of the polar rubber included in the balancing weight composition.

In some non-limiting embodiments, the balancing weight composition may include greater than 0 phr to 30 phr of the plasticizer based on 100 parts by weight (phr) of the polar rubber. If the amount of the plasticizer exceeds 30 phr, mixing efficiency may decrease due to stickiness when mixing the composition, and during extrusion molding, flow (wave pattern) may occur in the die section of the extruder, making it difficult to maintain the shape of the balancing weight.

### Other Additives

In one embodiment, the composition may further include any one selected from the group consisting of an acid accelerator, an anti-aging agent, a filler, and combinations thereof. In some non-limiting embodiments, the acid accelerator may include a metal oxide, a metal hydroxide, or the like. In some non-limiting embodiments, the anti-aging agent may include a diphenyl amine derivative, a phenylenediamine derivative, or the like. In some non-limiting embodiments, the processing aid may include stearic acid, zinc oxide, etc. The filler may include carbon black, kaolin clay, talc, diatomite, or the like.

In one embodiment, the balancing weight composition according to the present disclosure may include 1 phr to 2 phr of an inorganic oxide, 0.8 phr to 2 phr of a fatty acid, 5 phr to 30 phr of a plasticizer, and 500 phr to 1,580 phr of stainless steel (SUS) powder, based on 100 parts by weight (phr) of the polar rubber. When the amounts of the components of the balancing weight composition fall in the above numerical ranges, the composition may exhibit excellent blendability and bendability, high specific gravity, and superior chemical resistance including fuel resistance, ozone resistance, and weather resistance in a balanced manner.

In one embodiment, the balancing weight composition according to the present disclosure may not include (i.e., specifically excludes) a crosslinking agent or a crosslinking accelerator.

Typically, a balancing weight composition contains a crosslinking agent and/or a crosslinking accelerator. Here, the crosslinking agent includes a sulfur(S)-based crosslinking agent or a peroxide-based (DCP) crosslinking agent. In addition, crosslinking agents such as oxides of metal such as magnesium, aluminum, etc. may be used. When a crosslinking agent is added to the composition, crosslinking points may be formed through permanent chemical bonding between molecular chains, thereby forming a thermosetting material. Balancing weights manufactured from such compositions may have improved mechanical strength, but they are brittle, do not melt easily when heated, and emit toxic gases into the air when heated even more strongly, making them difficult to recycle.

In some non-limiting embodiments, the balancing weight composition according to the present disclosure includes polar rubber, which is a thermoplastic material and has excellent mutual attraction and adhesion with metal particles, and thus may not include or have any functional reason to include a separate crosslinking agent or crosslinking accelerator. Accordingly, the balancing weight composition according to the present disclosure may be more advantageous for recycling, such as reintroducing scrap generated during the process into the process or recovering the balancing weight manufactured from the balancing weight composition and converting the same back into a balancing weight composition again.

In one embodiment, the specific gravity of the balancing weight composition according to the present disclosure may be 3.0 or greater. If the specific gravity of the balancing weight composition is less than 3.0, a larger amount of the composition has to be used to make the weight of the balancing weight manufactured from the composition more than the required value, and thus the overall volume of the balancing weight may increase.

Another embodiment of the present disclosure relates to a balancing weight manufactured by compression molding of the balancing weight composition. Also, the balancing weight may be applied to a vehicle wheel. The components included in the balancing weight and the weight ratio thereof may be substantially similar to those included in the balancing weight composition.

Extrusion molding of the balancing weight composition may be performed using a typical process used in the relevant technical field, and may include, for example, heating a balancing weight composition to a predetermined temperature, extruding the heated resultant, and post-processing the extruded resultant.

During extrusion molding, the heating temperature may be a temperature range between the glass transition temperature and the melting point of the polar rubber, or a temperature range within and outside the melting point.

During extrusion molding, extrusion may proceed so as to form an extrudate having a desired shape. During extrusion molding, post-processing may include cutting the extrudate, printing the surface, etc. The extrusion molding may be performed using an extruder including a hopper configured to feed raw materials, a barrel configured to communicate with the hopper and to include a flow space for the raw materials, a stirrer configured to stir and move the raw materials in the flow space, a heater configured to heat the flow space, and an ejection die configured to communicate with the flow space. Also, a Banbury mixer, kneader, mixing roller, etc. may be applied to mix, blend, and disperse the balancing weight composition before extrusion molding.

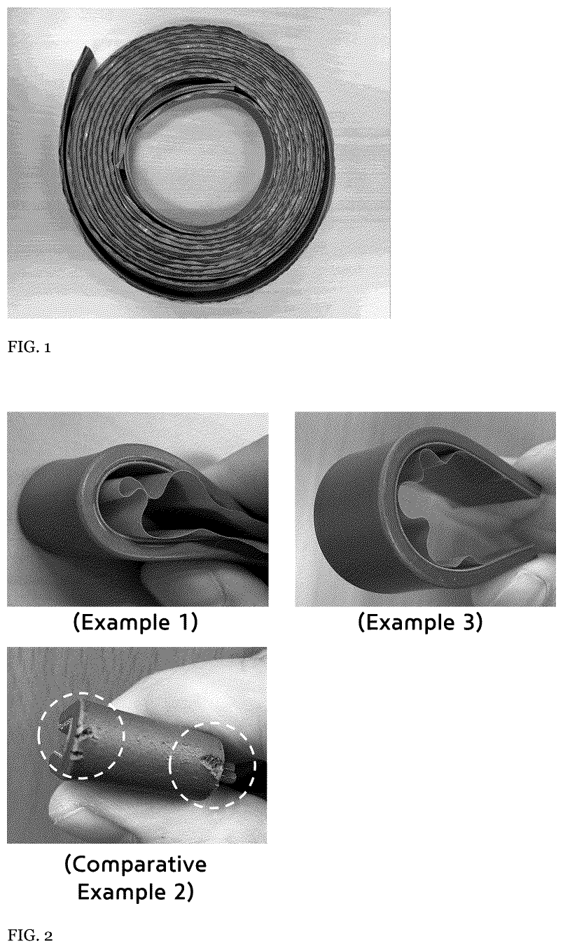

The balancing weight may be applied to parts and members that require the characteristics described above, and in some particular embodiments, may be applied to vehicle wheels. When applied as a wheel balance weight, the balancing weight may be formed in a long, rollable band shape as shown in FIG. 1. Also, a separate film may be further attached to one side and/or the remaining side of the balancing weight, and an adhesive film and a release film may also be attached.

A better understanding of the present disclosure may be obtained through the following examples and comparative examples. However, these examples are not to be construed as limiting the technical spirit of the present disclosure.

### Example 1

A molded body according to Example 1 was produced by mixing a composition including 2 phr of zinc oxide as an inorganic oxide, 1 phr of stearic acid as a fatty acid, 10 phr of naphthenic oil as a plasticizer, and 500 phr of ferritic stainless steel powder (D50: 30-120 μm) based on 100 parts by weight (phr) of nitrile butadiene rubber using a Banbury mixer followed by extrusion using a heating extruder (Thermo SCIENTIFIC/HAAKE).

### Example 2

A molded body according to Example 2 was produced in the same manner as in Example 1, with the exception that a composition including 3 phr of zinc oxide, 2 phr of stearic acid, 5 phr of naphthenic oil, and 1,200 phr of ferritic stainless steel powder (D50: 30-120 μm) based on 100 parts by weight (phr) of nitrile butadiene rubber was used.

### Example 3

A molded body according to Example 3 was produced in the same manner as in Example 1, with the exception that a composition including 4 phr of zinc oxide, 1.5 phr of stearic acid, 20 phr of naphthenic oil, and 1,580 phr of ferritic stainless steel powder (D50: 30-120 μm) based on 100 parts by weight (phr) of nitrile butadiene rubber was used.

### Example 4

A molded body according to Example 4 was produced in the same manner as in Example 1, with the exception that a composition including 1 phr of zinc oxide, 0.8 phr of stearic acid, 30 phr of naphthenic oil, and 900 phr of ferritic stainless steel powder (D50: 30-120 μm) based on 100 parts by weight (phr) of nitrile butadiene rubber was used.

### Comparative Example 1

A molded body according to Comparative Example 1 was produced in the same manner as in Example 1, with the exception that a composition including 0.5 phr of zinc oxide, 2 phr of stearic acid, 10 phr of naphthenic oil, and 500 phr of ferritic stainless steel powder (D50: 30-120 μm) based on 100 parts by weight (phr) of nitrile butadiene rubber was used.

### Comparative Example 2

A molded body according to Comparative Example 2 was produced in the same manner as in Example 1, with the exception that a composition including 5 phr of zinc oxide, 0.3 phr of stearic acid, 20 phr of naphthenic oil, and 1,700 phr of ferritic stainless steel powder (D50: 30-120 μm) based on 100 parts by weight (phr) of nitrile butadiene rubber was used.

### Comparative Example 3

A molded body according to Comparative Example 3 was produced in the same manner as in Example 1, with the exception that a composition including 2 phr of zinc oxide, 6 phr of stearic acid, and 1,600 phr of ferritic stainless steel powder (D50: 30-120 μm) based on 100 parts by weight (phr) of nitrile butadiene rubber, without a plasticizer, was used.

### Comparative Example 4

A molded body according to Comparative Example 4 was produced in the same manner as in Example 1, with the exception that a composition including 1 phr of zinc oxide, 1 phr of stearic acid, 35 phr of naphthenic oil, and 1,400 phr of ferritic stainless steel powder (D50: 30-120 μm) based on 100 parts by weight (phr) of nitrile butadiene rubber was used.

### Comparative Example 5

A molded body according to Comparative Example 5 was produced in the same manner as in Example 1, with the exception that a composition including 2 phr of zinc oxide, 1.5 phr of stearic acid, and 350 phr of ferritic stainless steel powder (D50: 30-120 μm) based on 100 parts by weight (phr) of nitrile butadiene rubber, without a plasticizer, was used.

### Comparative Example 6

A molded body according to Comparative Example 6 was produced in the same manner as in Example 1, with the exception that a composition including 4 phr of zinc oxide, 1 phr of stearic acid, 10 phr of naphthenic oil, and 1,750 phr of ferritic stainless steel powder (D50: 30-120 μm) based on 100 parts by weight (phr) of nitrile butadiene rubber was used.

### Comparative Example 7

A molded body according to Comparative Example 7 was produced in the same manner as in Example 1, with the exception that a composition including 1 phr of zinc oxide, 1 phr of stearic acid, 10 phr of naphthenic oil, and 1,800 phr of ferritic stainless steel powder (D50: 30-120 μm) based on 100 parts by weight (phr) of nitrile butadiene rubber was used.

### Comparative Example 8

A molded body according to Comparative Example 8 was produced in the same manner as in Example 1, with the exception that a composition including 55 phr of zinc oxide, 1.5 phr of stearic acid, 30 phr of naphthenic oil, and 1,550 phr of ferritic stainless steel powder (D50: 30-120 μm) based on 100 parts by weight (phr) of nitrile butadiene rubber was used.

### Reference Example 9

A molded body according to Reference Example 9 was produced in the same manner as in Example 1, with the exception that a composition including natural rubber (NR) as non-polar rubber, instead of nitrile butadiene rubber as the polar rubber, was used.

The compositions of the molded bodies according to Examples 1 to 4 and Comparative Examples 1 to 8 are as shown in Table 2 below.

TABLE 2

| | | Example | | | | Comparative Example | | | | | | | |
|---|---|---|---|---|---|---|---|---|---|---|---|---|---|
| Classification | | 1 | 2 | 3 | 4 | 1 | 2 | 3 | 4 | 5 | 6 | 7 | 8 |
| Polar rubber | | 100 | 100 | 100 | 100 | 100 | 100 | 100 | 100 | 100 | 100 | 100 | 100 |
| Activator | Inorganic | 2 | 3 | 4 | 1 | 0.5 | 5 | 2 | 1 | 2 | 4 | 1 | 55 |
| | oxide | | | | | | | | | | | | |
| | Fatty acid | 1 | 2 | 1.5 | 0.8 | 2 | 0.3 | 6 | 1 | 1.5 | 1 | 1 | 1.5 |

| | | | | | | | | | | | | |
|---|---|---|---|---|---|---|---|---|---|---|---|---|
| Plasticizer | 10 | 5 | 20 | 30 | 10 | 20 | 0 | 35 | 0 | 10 | 10 | 30 |
| Metal particles | 500 | 1,200 | 1,580 | 900 | 500 | 1,700 | 1,600 | 1,400 | 350 | 1,750 | 1,800 | 1,550 |

### Test Example 1—Measurement of Blendability

In order to determine blendability of the balancing weight composition according to the present disclosure, the components of the composition were blended using a Banbury mixer and then the blendability of the composition was observed with the naked eye. Also, the appearance of the molded body extruded using a heating extruder was observed with the naked eye. The results thereof are shown in Table 3 below. Here, if the metal particle powder was separated or mixing was difficult, it was judged as ‘poor.’

### Test Example 2—Measurement of Properties

In order to investigate various properties of the molded body produced using the balancing weight composition according to the present disclosure, bendability, specific gravity, fuel resistance, ozone resistance, and weather resistance tests were conducted using the following methods. The results thereof are shown in Table 3 below.

### 1) Evaluation of Bendability

The molded body was cooled at room temperature and cut into a specimen having a size of 23 mm in width, 100 mm in length, and 4.5 mm in thickness. At a temperature of 23° C. and a relative humidity of 50%, one cycle including bending for 2 seconds so that the angle between one end and the remaining end in the longitudinal direction of the molded body was 45 degrees and then returning to the original state was repeated until cracking occurred. Some results of evaluation of bendability are shown in FIG. 2. If splitting or breakage was observed with the naked eye, it was judged as a ‘cracking’ and the number of cycles the cracking occurred was recorded.

### 2) Specific Gravity

The molded body was cooled at room temperature and cut into a specimen having a size of 23 mm in width, 100 mm in length, and 4.5 mm in thickness. The specific gravity was measured under conditions of 25° C. and 1 atm without applying external force using an electronic densimeter (ALFA MIRAGE).

### 3) Evaluation of Fuel Resistance

Referring to the MS268-05 standard of KATRI Testing & Research Institute, the molded body was cooled at room temperature and then cut into a specimen having a size of 20 mm in width, 20 mm in length, and 4.5 mm in thickness. The specimen was immersed in gasoline for 2 hours, then taken out and visually observed for breakage, splitting, whitening, or rust generation. If swelling or peeling was not observed, it was judged as ‘good.’

### 4) Evaluation of Ozone Resistance

Referring to the MS269-03 standard of KATRI Testing & Research Institute, the molded body was cooled at room temperature and then cut into a specimen having a size of 20 mm in width, 20 mm in length, and 4.5 mm in thickness. The specimen was exposed to ozone with a concentration of 50 pphm at a temperature of 40° C. for 72 hours and then the surfaces thereof were analyzed. Some results of evaluation of ozone resistance are shown in FIG. 4. Here, if surface cracking or splitting was not observed, it was judged as ‘good’.

### 5) Evaluation of Weather Resistance

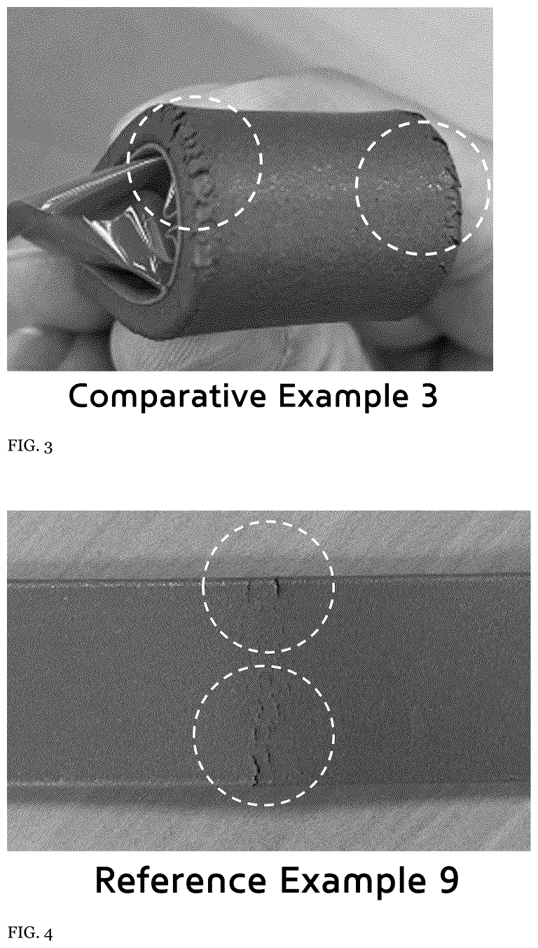

Referring to the MS210-06 standard of parts under visible conditions of KATRI Testing & Research Institute, the molded body was cooled at room temperature and then cut into a specimen having a size of 20 mm in width, 20 mm in length, and 4.5 mm in thickness. For the specimen, one cycle including irradiation with 0.75 W/m² of ultraviolet light at 340 nm for 120 minutes and spray with water in the dark for 60 minutes was repeated until the ultraviolet irradiation dose reached 2,500 KJ/m³, followed by measurement of discoloration, migration, and whitening. Some results of evaluation of weather resistance are shown in FIG. 3. Here, if discoloration, migration, or whitening did not occur, it was judged as ‘satisfactory.’

TABLE 3

Example

| Classification | 1 | 2 | 3 | 4 |
|---|---|---|---|---|
| Blendability | Good | Good | Good | Good |
| Bendability | 50↑ | 50↑ | 50↑ | 50↑ |
| Specific | 3.52 | 4.33 | 4.98 | 3.98 |
| gravity | | | | |
| Fuel | Good | Good | Good | Good |
| resistance | | | | |
| Ozone | Satisfactory | Satisfactory | Satisfactory | Satisfactory |
| resistance | | | | |
| Weather | Satisfactory | Satisfactory | Satisfactory | Satisfactory |
| resistance | | | | |

| | Comparative Example | | | | | | | |
|---|---|---|---|---|---|---|---|---|
| Classification | 1 | 2 | 3 | 4 | 5 | 6 | 7 | 8 |
| Blendability | Poor | Poor | Good | Poor | Good | Poor | Poor | Poor |
| Bendability | — | Cracking | 50↑ | — | 50↑ | Cracking | Cracking | Cracking |
| | | at 40^{th} | | | | at 40^{th} | at 35^{th} | at 40^{th} |
| | | cycle | | | | cycle | cycle | cycle |
| Specific | 3.33 | 4.75 | 4.82 | 4.55 | 2.82 | 4.72 | 4.73 | 5.01 |
| gravity | | | | | | | | |
| Fuel | — | — | — | — | — | — | — | — |
| resistance | | | | | | | | |
| Ozone | — | — | — | — | — | — | — | — |
| resistance | | | | | | | | |
| Weather | | | Discoloration/ | Discoloration/ | | | | |
| resistance | | | migration/ | migration | | | | |
| | | | cracking | | | | | |

Referring to Table 3 and FIG. 2, Examples 1 to 4 exhibited good composition blendability (mixing/extrusion appearance), and superior bendability, fuel resistance, ozone resistance, and weather resistance in a balanced manner. Moreover, the composition had a specific gravity exceeding 3.0, making it suitable for use as a balancing weight.

Referring to the results of Comparative Examples 1 and 8 in which the amount of zinc oxide added as an inorganic oxide of the activator was controlled, powder separation was observed in Comparative Example 1 based on results of measurement of blendability. This is deemed to be due to the excessively low amount of zinc oxide added as the inorganic oxide of the activator.

Also, in Comparative Example 8, the powder was observed to agglomerate based on results of measurement of blendability, and cracking occurred at the 40th cycle based on results of measurement of bendability. This is deemed to be because the amount of the inorganic oxide was excessively high, causing agglomeration of metal particle powder and a decrease in fatigue resistance due to reduced dispersibility.

Referring to the results of Comparative Examples 2 and 3 in which the amount of stearic acid added as a fatty acid of the activator was controlled, in Comparative Example 2, powder separation was observed based on results of measurement of blendability, and as can be seen in FIG. 2, cracking was observed at the 40th cycle based on results of testing of bendability. This is deemed to be because the amount of stearic acid, which was added as the fatty acid of the activator, was excessively low, making it difficult to obtain filling properties of the metal particles, and thus effective adhesion between the polar rubber and the metal particles became difficult, resulting in powder separation and material splitting.

Also, Comparative Example 3 exhibited good blendability, but discoloration and migration were observed based on results of measurement of weather resistance, and as can be seen in FIG. 3, cracking was observed when the specimen was bent after the weather resistance test. This is deemed to be due to accumulation of unreacted stearic acid, causing powder separation during mixing, resulting in discoloration and migration.

In Comparative Example 4, a sticky phenomenon was caused based on results of measurement of blendability, and flow occurred in the die section of the extruder, making it difficult to maintain the shape of the balancing weight. Also, discoloration and migration were observed based on results of testing of weather resistance. This is deemed to be because the viscosity of the composition became excessively low due to mixing of an excess of the plasticizer.

In Comparative Example 5, there was no problem with results of measurement of blendability, but the specific gravity was measured to be 2.82, which is evaluated to be less than 3.0. This is deemed to be because the metal particles having high specific gravity were added in a very low amount, and when the composition according to Comparative Example 5 is applied to an actual product, the volume may increase compared to Examples of the same weight, resulting in increased noise during driving.

In Comparative Example 6, separation of the metal particle powder was observed based on results of measurement of blendability, and cracking was observed at the 40^{th} cycle based on results of testing of bendability. Also, in Comparative Example 7, separation of the metal particle powder was observed based on results of measurement of blendability, and cracking was observed at the 35^{th} cycle based on results of testing of bendability. This is deemed to be because the amount of the metal particles in the composition was excessively high, making mixing between the polar rubber and the metal particle powder difficult. Furthermore, cracking was predicted to occur before 50 cycles in 45-degree repeated bending evaluation due to poor adhesion performance between the polar rubber and the metal particles.

Meanwhile, in Reference Example 9 using natural rubber, which is non-polar rubber, microcracking was confirmed to occur based on results of testing of ozone resistance, as can be seen in FIG. 4.

As is apparent from the foregoing, according to the present disclosure, a balancing weight composition with excellent chemical resistance and high specific gravity by including polar rubber having excellent chemical resistance such as heat resistance, hydrolysis resistance, fuel resistance, weather resistance, and ozone resistance and metal particles having high specific gravity can be provided. Also, corrosion resistance can be improved using stainless steel powder as metal particles.

The balancing weight composition according to the present disclosure can be easily molded, and a balancing weight to which the composition is applied can have high adhesion to the curved surface of a vehicle wheel.

In addition, the balancing weight to which the balancing weight composition according to the present disclosure is applied has fatigue resistance against repeated bending that occurs during a mass production process or balancing operation, and is capable of alleviating the problem of reduced productivity.

In addition, a molded body to which the balancing weight composition according to the present disclosure is applied can exhibit a work defect rate decreased by 50% or more compared to a conventional steel-type product when applied to a wheel. Moreover, the molded body to which the composition according to the present disclosure is applied enables precise balancing in small units of 0.5 g, thereby realizing a low wheel balancing error rate, minimizing noise generation in a vehicle driving mode, and minimizing interference with a brake caliper.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A balancing weight composition, comprising polar rubber; an activator; and metal particles, wherein the balancing weight composition comprises, based on 100 parts by weight (phr) of the polar rubber, 1.5 phr to less than 60 phr of the activator and greater than 350 phr to less than 1,750 phr of the metal particles.

2. The balancing weight composition of claim 1, wherein the polar rubber comprises nitrile butadiene rubber (NBR), hydrogenated nitrile butadiene rubber (H-NBR), chloroprene rubber (CR), or combinations thereof.

3. The balancing weight composition of claim 2, wherein the nitrile butadiene rubber has a Mooney viscosity (ML1+4) of 40 to 75 at 100° C.

4. The balancing weight composition of claim 2, wherein the hydrogenated nitrile butadiene rubber has a Mooney viscosity (ML1+4) of 55 to 75 at 100° C.

5. The balancing weight composition of claim 2, wherein the chloroprene rubber has a Mooney viscosity (ML1+4) of 30 to 60 at 100° C.

6. The balancing weight composition of claim 1, wherein the activator comprises an inorganic oxide, a fatty acid, or combinations thereof.

7. The balancing weight composition of claim 6, wherein the inorganic oxide comprises zinc oxide (ZnO), tin oxide (SnO₂), aluminum oxide (Al₂O₃), zirconium oxide (ZrO₂), or combinations thereof.

8. The balancing weight composition of claim 6, wherein:
the fatty acid is selected from the group consisting of a saturated fatty acid and an unsaturated fatty acid, wherein
the saturated fatty acid comprises stearic acid, caprylic acid, lauric acid, myristic acid, arachidic acid, or combinations thereof, and
the unsaturated fatty acid comprises oleic acid, elaidic acid, linoleic acid, ricinoleic acid, or combinations thereof.

9. The balancing weight composition of claim 6, wherein the balancing weight composition comprises from 1 phr to 55 phr of the inorganic oxide and from 0.5 phr to 5 phr of the fatty acid.

10. The balancing weight composition of claim 1, wherein the metal particles comprise austenitic stainless steel, ferritic stainless steel, martensitic stainless steel, or combinations thereof.

11. The balancing weight composition of claim 1, wherein an average particle diameter (D50) of the metal particles is from 1 μm to 150 μm.

12. The balancing weight composition of claim 1, wherein:
the metal particles have a particle size of 30 μm to 120 μm,
the metal particles have a tap density of 6.0 to 10.0 g/cm³, and
the metal particles have an apparent density of is 4.0 to 8.0 g/cm³.

13. The balancing weight composition of claim 1, further comprising a plasticizer.

14. The balancing weight composition of claim 13, wherein the plasticizer comprises a paraffinic compound, a naphthenic compound, an olefinic compound, an aromatic compound, or combinations thereof.

15. The balancing weight composition of claim 13, wherein the balancing weight composition comprises from greater than 0 phr to 30 phr of the plasticizer, based on 100 parts by weight (phr) of the polar rubber.

16. The balancing weight composition of claim 1, further comprising any one or more of an acid acceptor, an anti-aging agent, a filler, or combinations thereof.

17. The balancing weight composition of claim 1, comprising, based on 100 parts by weight (phr) of the polar rubber:
1 phr to 2 phr of an inorganic oxide;
0.8 phr to 2 phr of a fatty acid;
5 phr to 30 phr of a plasticizer; and
500 phr to 1,580 phr of the metal particles.

18. The balancing weight composition of claim 1, wherein the balancing weight composition does not comprise a crosslinking agent or a crosslinking accelerator.

19. A balancing weight manufactured by compression molding of the balancing weight composition of claim 1.

20. A vehicle wheel comprising the balancing weight of claim 19.
